(19) United States
(12) Patent Application Publication
(10) Pub. No.: US 2026/0158865 A1
(43) Pub. Date: Jun. 11, 2026

(54) Cooling System for a Motor Vehicle

(71) Applicant: MAHLE International GmbH, Stuttgart (DE)

(72) Inventor: Rainer Lutz, Steinheim (DE)

(21) Appl. No.: 19/409,386

(22) Filed: Dec. 4, 2025

(30) Foreign Application Priority Data
Dec. 6, 2024 (DE) 102024136485.8
Nov. 11, 2025 (DE) 102025146442.1

(51) Int. Cl. B60H 1/00

(52) U.S. Cl. CPC B60H 1/00907; B60H 1/00278

(57) ABSTRACT

A cooling system (1) for a motor vehicle is provided. The cooling system contains, containing a first thermal management module and a second thermal management module wherein the first thermal management module contains a first refrigerant circuit and the second thermal management module (500) contains a second refrigerant circuit (505), wherein the first refrigerant circuit contains a first indirect condenser (303), first chiller and second chiller which is parallel to the first chiller wherein the second refrigerant circuit contains a second indirect condenser (502) and third chiller

### CROSS-REFERENCE TO RELATED APPLICATIONS

This application claims priority from German Patent Application Numbers 102024136485.8, filed on Dec. 6, 2024 and 102025146442.1 filed on Nov. 11, 2025, the entirety of each are incorporated by reference herein.

The invention relates to a cooling system for an electric vehicle, in particular a truck, according to the independent claims.

The object of the invention is to design a cooling system for a motor vehicle, in particular a truck with an electric drive, such that the resulting heat can be used advantageously to efficiently heat the cab of the vehicle, using as few switching components as possible and occupying as little space as possible.

The present cooling system for an electric vehicle according to the features of Numbered Paragraph 1 and the independent Numbered Paragraphs is therefore proposed.

The cooling system obtained with the invention contains a first thermal management module with a first refrigerant circuit and a second thermal management module with a second refrigerant circuit. The first thermal management module, with the first refrigerant circuit, contains a first indirect condenser, a first chiller, and a second chiller. The second thermal management module contains a second indirect condenser and a third chiller.

A thermal management module is a structural unit combining numerous components. The thermal management modules obtained with the invention contain a refrigerant circuit with at least one chiller and indirect condenser, as well as a compressor and potentially numerous expansion valves. By integrating the refrigerant circuit in a thermal management module, a particularly compact module is obtained that requires little space and can be easily placed in the engine compartment in a motor vehicle.

The thermal management module forms an indirect heat pump circuit. The cold refrigerant discharges heat to a coolant in the indirect condenser, and heat from a coolant is transferred to the refrigerant in the chiller.

R290 (propane) or R774 (CO₂) is used as the refrigerant in the refrigerant circuit in modern electric vehicles. Other refrigerants can also be used, e.g. R1234yf.

Water, potentially mixed with an antifreeze, or other coolants such as low viscosity oils, can be used for the coolant.

Heat and cold can be provided to the vehicle as needed by two independent refrigerant circuits, depending on how and where the vehicle is being operated.

The first chiller can be connected to a cooling element in the vehicle's cab. The cab cooling element cools the cab, e.g. when it is hot outside, providing the driver with a pleasant thermal environment.

The cooling system is preferably used in an electric truck that contains a battery and electronic components with which it is operated. The cab is the central workplace of the driver and must therefore be cooled and heated to allow the driver to work effectively. The cab is where the driver spends time on breaks, and potentially sleeps as well. This is why it has to be heated and cooled effectively. To ensure that this does not substantially impact the travel range of the vehicle, e.g. when there is no charging possibility where the vehicle is parked, this must be particularly efficient, in order to conserve valuable electricity for driving.

Coolant is cooled in the first chiller, and then sent to the cooling element in the cab, through which air flows. This cools the air. The cab cooling element is a heat exchanger, typically a finned tube heat exchanger. There are fins through which air flows between the tubes through which the coolant flows. This results in an efficient heat exchange.

The second and third chillers can be connected to a battery cooling circuit. the battery cooling circuit cools at least one battery with the coolant that has been cooled in the second and/or third chiller.

Batteries in electric vehicles emit a lot of heat when charging or used to power the vehicle, which must be discharged to ensure that the batteries function properly. Consequently, particularly in a quick charging process, a lot of heat may be generated quickly, requiring a variable cooling capacity. Where there are two independent refrigerant circuits, the second can be activated in order to obtain coolant cooled in both refrigerant circuits by the second and third chillers.

When it is very cold outside, or with a cold start of the vehicle, it may be necessary to heat the battery in order to bring it to the necessary operating temperature as quickly as possible. An optional heater may be placed in the battery cooling circuit for this, which heats the coolant to the necessary temperature, or contributes to the heating process.

An additional chiller can be placed in the second thermal management module, in the second refrigerant circuit. This fourth chiller is connected in parallel to the third chiller and receives the same amount of refrigerant. Consequently, significantly more heat can be transferred from the coolant to the refrigerant, resulting in more available cooled coolant, in particular for cooling the battery cooling circuit. This further increases the cooling capacity, such that there is always sufficient cooled coolant available. Specifically with electric trucks, large batteries are used, which are charged with 800-1000 kilowatts. Consequently, in quick charging processes in the megawatt range, which still take some time due to the size of the batteries, a lot of waste heat must be discharged.

There can also be a second and third switching valve upstream and downstream of the third chiller. These second and third switching valves can be switched, or regulated, such that the third chiller can be at least partially disconnected from the battery cooling circuit, while the second refrigerant circuit nevertheless remains in operation. If there is a fourth chiller, connected in parallel to the third, both chillers can therefore be connected.

The first indirect condenser can have a first coolant outlet and the second indirect condenser can have a second coolant outlet. Both outlets open into the same heating circuit intake line. There can also be a check valve between the heating circuit intake line and the second coolant outlet.

The second indirect condenser can be shut off by the check valve if the second refrigerant circuit is disconnected. This prevents current losses in the second condenser.

There can be first and second coolant coolers in the cooling system. A coolant cooler is a heat exchanger, or radiator, through which air from the exterior flows, such that heat can be exchanged between the coolant flowing through the coolant cooler and the air. Heat can be either discharged to the exterior, or absorbed therefrom, which can then be used in the heat pump. When the vehicle is stationary, a fan can be used to convey air to the coolant cooler.

A cab heating circuit can also be incorporated in the cooling system, which is then connected to the heating circuit intake line. A first switching valve can be placed in the heating circuit intake line. The first switching valve can be a 3-way valve that can also be connected by an intake line to the first coolant cooler. The first switching valve can be regulated such that it can precisely distribute the coolant heated in the first and/or second condensers.

The cab heating circuit can contain a first cab coolant pump and a high-voltage heater. There can also be a bypass valve for a cab heating circuit bypass. The coolant in the cab heating circuit is circulated by the first cab coolant pump. If necessary, the cab heating circuit bypass can be activated such that the coolant can circulate in a small circuit. In this case, the high-voltage heater, preferably a radiator, can heat the coolant, which can then be used to heat the cab. This results in an isolated cab heating circuit that is independent of the refrigerant circuits. This has advantages when the vehicle is stationary, i.e. while the driver is taking a break, when the other cooling functions of the vehicle are unnecessary. In the case of a cold start, the coolant in the cab heating circuit is also heated by the high-voltage heater. In this case, the cab heating circuit bypass should also be activated in order to prevent heat losses from the cab heating circuit.

A combination is also conceivable, in which the cab bypass valve only partially activates the cab heating circuit bypass, thus contributing heat from the indirect condensers as well, such that the high-voltage heater for the cab contributes to the heating in the cooling system.

The cooling system can also contain an electronics cooling circuit that can be connected to the second coolant cooler by first and second electronics circuit valves. An electronics circuit cooler bypass with an electronics circuit bypass valve can be placed upstream of the second coolant cooler. There is at least one electronic component that requires cooling in the electronics cooling circuit. An electronics circuit coolant pump can also be placed in the electronics cooling circuit for circulating the coolant.

Coolant circulates through the electronics cooling circuit such that heat from the at least one electronic component that needs cooling can be absorbed. The heated coolant can then be conducted to the second coolant cooler where it can then be transferred to the exterior. If not too much heat is generated, the electronics circuit cooler bypass can be activated by the bypass valve, such that the coolant bypasses the second coolant cooler. Consequently, the coolant can be slowly heated in the electronics cooling circuit, without heat losses to the exterior. The electronics components are then cooled by the second coolant cooler under normal conditions.

The cooling system can also contain a braking resistor cooling circuit. The braking resistor cooling circuit contains a braking resistor and a braking resistor coolant pump. The braking resistor cooling circuit is connected to the second coolant cooler. This braking resistor in trucks forms a supplementary braking system to the existing braking system, particularly when driving downhill, and can also be used to slow the regeneration capacity of the drive motors. A braking resistor converts kinetic energy into heat, mechanically or with electronic resistance. This heat then ends up in the braking resistor cooling circuit and is conducted by the braking resistor coolant pump through the second coolant cooler, where the heat can then be transferred to the exterior.

The cooling system can also contain a third coolant cooler. This can be used exclusively for cooling the braking resistor cooling circuit, such that the exhaust heat from the braking resistor is conducted by the braking resistor coolant pump exclusively to the third coolant cooler where it can be cooled by air from the exterior.

First and second electronics circuit valves can be placed upstream and downstream of the second coolant cooler. These valves can be 3-way valves with which the coolant can be controlled and regulated in a variety of ways. If, for example, the braking resistor cooling circuit is connected to the second coolant cooler by activating the braking resistor coolant pump, there is no longer any intake of coolant from the electronics cooling circuit. To be able to continue cooling the coolant from the electronics cooling circuit, the first and second electronics circuit valves can conduct the coolant to the first coolant cooler, where heat can then be transferred to the exterior.

The first and second coolant coolers can thus be coupled, such that coolant can flow in parallel through both coolant coolers.

A fourth switching valve can be placed in a cab heating circuit return line that returns coolant from the cab heating circuit, connecting this return line to a condenser intake, which conducts coolant from the first coolant cooler back to the first and second indirect condensers.

The first coolant cooler cools the two indirect condensers in the first and second thermal management modules during normal operation. There are two of these in order to satisfy the very high cooling needs arising when driving downhill with heavy loads or at megawatt level charges. Furthermore, they optimize power consumption, because the optimal temperatures for the cab and battery can be set. The first switching valve can send the heated coolant from the indirect condenser to the cab heating circuit.

The first chiller in the first thermal management module cools the cab, and the second chiller contributes to the cooling of the battery if needed. The third chiller in the second thermal management module is only used to cool the battery during normal operation.

The cooling circuit can be placed in a motor vehicle, in particular a truck that has a battery and an electric drive.

Other advantageous embodiments and features of the invention are described below in reference to the drawings. Therein:

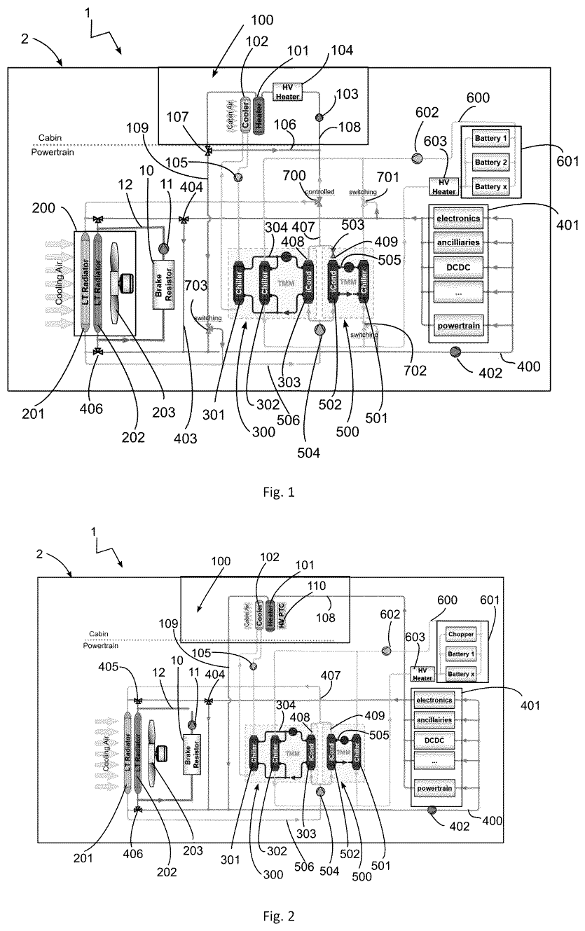

FIG. 1 shows a schematic illustration of the cooling system obtained with the invention, with a heat pump;

FIG. 2 shows a schematic illustration of the cooling system obtained with the invention, without a heat pump;

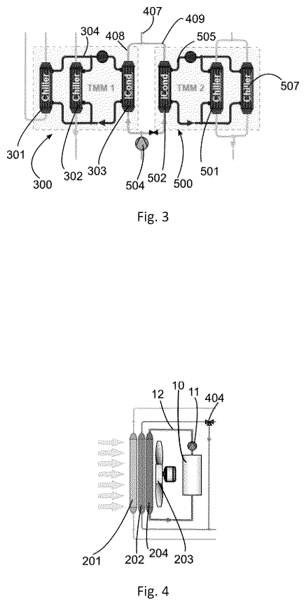

FIG. 3 shows a section of the cooling system obtained with the invention, which contains four chillers; and

FIG. 4 shows a section of the cooling system obtained with the invention, with three coolant coolers.

### PREFERRED EMBODIMENTS OF THE INVENTION

FIG. 1 shows the schematic structure of a cooling system 1 obtained with the invention in a motor vehicle 2.

The cooling system 1 contains an electronics cooling circuit 400 through which coolant flows. Water, potentially mixed with antifreeze, or other coolants, e.g. low viscosity oils, can be used for the coolant.

The electronics cooling circuit 400 contains electronic components 401 that are cooled in parallel and/or series with coolant. These electronic components 401 can be the drive motor for the vehicle 2, power electronics in the vehicle 2, power converters, e.g. for the charging process, or other components that require cooling when in use, and which can discharge heat. The electronics cooling circuit 400 is connected to a second coolant cooler 202, which can be placed in a cooling module 200. There is also an electronics circuit coolant pump 402 in the electronics cooling circuit 400 that circulates the coolant therein.

The cooling module 200 is preferably placed in the front part of the vehicle 2, such that air from the exterior can flow through it. This air can absorb heat from a coolant flowing through the second coolant cooler 202, and discharge it to the exterior, or it can absorb heat from the exterior.

The cooling module 200 also contains a first coolant cooler 201 and a fan 203. Coolant also flows through the first coolant cooler 201, and can exchange heat with the exterior.

An electronics circuit cooler bypass 403 with an electronics circuit bypass valve 404 is upstream of the second coolant cooler 202 in the electronics cooling circuit 400, with which the coolant cooler 202 can be entirely or partially bypassed, such that no, or only some, coolant reaches the second coolant cooler 202.

There is a braking resistor 10 in the vehicle 2, which can contribute to the braking effect in the vehicle. This converts kinetic energy into heat that must be discharged. This may be activated when driving downhill, for example, if the vehicle brakes and engine braking are insufficient. This can be incorporated in the electronics cooling circuit 400 to cool the braking resistor 10, such that a braking resistor coolant pump 11 can conduct coolant to the second coolant cooler 202 where it can be cooled.

The electronics cooling circuit 400 contains first and second electronics circuit valves 405, 406 at the intake and outlet on the second coolant cooler 202, with which different switching configurations can be implemented. By way of example, when the braking resistor is actively cooled, the coolant cooler 202 can be activated individually for this, while the electronics circuit 400 is cooled by the first coolant cooler 201.

The cooling system 1 contains a battery cooling circuit 600 through which coolant flows. The battery cooling circuit 600 contains at least one battery that powers the vehicle 1, providing the electricity for the driver motor and for all other electronic components in the vehicle 2. The battery cooling circuit 600 contains a coolant pump 602 that circulates the coolant through the battery cooling circuit 600. The battery cooling circuit 600 can also contain a heater 603 that heats the battery cooling circuit 600 with electricity in order to quickly heat the battery 601 to a desired temperature, in particular when it is cold outside.

The vehicle 2 has a cab 100 for the driver that requires heating or cooling. There is a heater 101 and a cooling element 102 in the cab 100 for this, through both of which air can flow. The heater 101 is used to heat the cab 100 when warm coolant flows through it, thus heating the air entering the cab 100. The cooling element 102 cools the cab 100 when cold coolant flows through it, thus cooling the air entering the cab 100. Both heat exchangers 101, 102 in the cab 100 can be switched on to dehumidify the air.

A high-voltage heater 104 can be placed upstream of the cab heater 101 to contribute to the heating. A cab heating circuit bypass 106 with a cab bypass valve 107 bypasses the cab heating circuit, reducing the size of the heating circuit. A first cab coolant pump 103 can be used for this, which powers the small heating circuit when the high-voltage heater 104 is in use, such that the cab 100 can be heated independently of other heat sources.

The cooling system 1 contains a first thermal management module 300 and second thermal management module 500.

A thermal management module 300, 500 is a structural unit composed of various components, comprising at least one refrigerant circuit, one compressor, one indirect condenser, and one chiller. The indirect condenser, compressor, and chiller are incorporated in the refrigerant circuit. The refrigerant can be R290 (propane), or some other conventional refrigerant. These components are preferably on a module support structure that also contains fluid lines and other components such as expansion valves and sensors, thus forming a structural unit that can be placed in a vehicle 2. An indirect condenser is a heat exchanger through which coolant and refrigerant can flow, thus exchanging heat. An indirect condenser preferably transfers heat to the coolant.

The first and second thermal management modules 300, 500 can conceivably be combined to form a single structural unit if there is enough space in the vehicle 2.

The first thermal management module 300 contains a first chiller 301 and second chiller 302, which are incorporated in parallel in the refrigerant circuit. The thermal management module 300 also contains a first indirect condenser 303.

The thermal management module 500 contains a third chiller 501 and a second indirect condenser 502, as well as a check valve 503 with which the outlet on the second indirect condenser 502 can be closed, such that coolant can no longer flow through it. This is necessary if less battery heat is to be used as a heat source for the heat pump.

Coolant flows through the first indirect condenser 303 and second indirect condenser 502, which are parallel to one another. A condenser coolant pump 504 can be placed upstream of the indirect condensers 303, 502.

The electronics cooling circuit 400, battery cooling circuit 600 and coolant lines to the cab heater can contain switching valves 700, 701, 702, 703, which are 3-way or 4-way valves, and can be connected to one another in a variety of ways.

The indirect condensers 303, 502 in the first and second thermal management modules 300, 500 can be used as heat sources for the cab heater 101 when connected thereto by the first and fourth switching valves 700, 703. If the amount of coolant in the indirect condensers 303, 502 is too much for the cab heater 101, it is advantageous if the first and/or second fourth switching valves 700, 703 are adjustable.

The first and second thermal management modules 300, 500 normally use the battery 601 as a heat source. If the exhaust heat from the battery 601 is insufficient, e.g. when operated in the light load mode, the electronics cooling circuit 400 with the third chiller 501 can connected in the second thermal management mode 500, instead of the battery 601, by the second and third switching valves 701, 702.

FIG. 2 shows another exemplary embodiment of the cooling system 1 obtained with the invention. This cooling system does not have some of the switching valves, and is therefore simpler. Specifically, the electronics circuit 400 is connected directly to the cab heating circuit 108, such that the heat from the electronics circuit 400 can be used directly for heating the cab 100 with the heater 101. Even when the coolant is cold, e.g. with a cold start of the vehicle 2, an additional air heater 110 can be used to sufficiently heat the cab 100, which heats the air entering the cab electrically, thus contributing to the heating of the cab 100. In this embodiment, the first, second, third, and fourth switching valves 700, 701, 702, 703 with which the different cooling circuits can be connected to one another, are also omitted. This results in a particularly inexpensive cooling system 1, which is missing a few regulating possibilities and therefore efficiency possibilities, but still has the fundamental qualities of the cooling system 1.

FIG. 3 shows another exemplary embodiment of the cooling system 1 obtained with the invention, in which only a part is illustrated, showing the first and second thermal management modules 300, 500. In addition to the first and second chillers 301, 302 in the first thermal management module 300, the second thermal management module 500 also has two chillers 501, 507 placed in parallel in the refrigerant circuit 505. This increases the cooling capacity for battery circuit 600, such that the battery can always be sufficiently cooled. Electric trucks contain large batteries that are to be charged to 800-100 kW. Consequently, a lot of exhaust heat must be discharged in a quick charging process in the megawatt range, which takes some time due to the size of the batteries.

FIG. 4 shows another exemplary embodiment of the cooling system 1 obtained with the invention, in which there is a third coolant cooler 204, which is configured exclusively for cooling the braking resistor 10. A braking resistor cooling circuit 12 is therefore formed, in which coolant is circulated by a coolant pump 11. The heat generated by the braking resistor 10 is discharged to the exterior by the third coolant cooler 204. Consequently, the first and second coolant coolers 201, 202 can be used independently for discharging heat from the battery circuit 500 and electronics circuit 400, or for discharging heat from the two indirect condensers 303, 502.

The specification can be readily understood with reference to the following Numbered Paragraphs:
Numbered Paragraph 1. A cooling system (1) for a motor vehicle (2), containing a first thermal management module (300) and a second thermal management module (500), wherein the first thermal management module (300) contains a first refrigerant circuit (304) and the second thermal management module (500) contains a second refrigerant circuit (505), wherein the first refrigerant circuit (304) contains a first indirect condenser (303), first chiller (301), and second chiller (302), which is parallel to the first chiller (301), wherein the second refrigerant circuit (505) contains a second indirect condenser (502) and third chiller (501).
Numbered Paragraph 2. The cooling system (1) for a motor vehicle (2) according to Numbered Paragraph 1, characterized in that the first chiller (301) is connected to a cab cooling element (102) in the driver's cab (100), wherein the second chiller (302) and third chiller (501) are connected to a battery cooling circuit (600), wherein the battery cooling circuit (600) contains at least one battery (601).
Numbered Paragraph 3. The cooling system (1) for a motor vehicle (2) according to Numbered Paragraph 1 or 2, characterized in that the second refrigerant circuit (505) contains a fourth chiller (507) in parallel to the third chiller (501).
Numbered Paragraph 4. The cooling system (1) for a motor vehicle (2) according to Numbered Paragraph 2 or 3, characterized in that a second switching valve (701) is upstream of the third chiller (501) and a third switching valve (702) is downstream of the third chiller (501).
Numbered Paragraph 5. The cooling system (1) for a motor vehicle (2) according to any of the preceding Numbered Paragraphs, characterized in that a first coolant outlet (408) on the first indirect condenser (303) and a second coolant outlet (409) on the second indirect condenser (502) open into the same heating circuit intake line (407), wherein there is a check valve (503) between second coolant outlet (409) and the heating circuit intake line (407).
Numbered Paragraph 6. The cooling system (1) for a motor vehicle (2) according to Numbered Paragraph 5, characterized in that the cooling system (1) contains a first coolant cooler (201), a second coolant cooler (202), and a cab heating circuit (108), wherein the first coolant cooler (201) and cab heater (108) can be connected to one another by a first switching valve (700).
Numbered Paragraph 7. The cooling system (1) for a motor vehicle (2) according to Numbered Paragraph 6, characterized in that the cab heating circuit (108) contains a first coolant pump (103), and a high-voltage heater (104), wherein there is a cab bypass valve (107), with which a cab heating circuit bypass (106) can be activated.
Numbered Paragraph 8. The cooling system (1) for a motor vehicle (2) according to Numbered Paragraph 6 or 7, characterized in that the cooling system (1) contains an electronics cooling circuit (400), which can be connected to the second coolant cooler (202) by a first electronics circuit valve (405) and second electronics circuit valve (406), wherein an electronics circuit cooler bypass (403) with an electronics circuit bypass valve (404) is upstream of the second coolant cooler (202), wherein the electronics cooling circuit (400) contains at least one electronic component (401) that requires cooling.
Numbered Paragraph 9. The cooling system (1) for a motor vehicle (2) according to Numbered Paragraph 8, characterized in that the cooling system (1) contains a braking resistor cooling circuit (12), which contains a braking resistor (10) and a coolant pump (11), wherein the braking resistor cooling circuit (12) is connected to the second coolant cooler (202) or a third coolant cooler (204).
Numbered Paragraph 10. The cooling system (1) for a motor vehicle (2) according to Numbered Paragraph 9, characterized in that the second coolant cooler (202) can be connected to the first coolant cooler (201) by the first electronics circuit valve (405) and the second electronics circuit valve (406).
Numbered Paragraph 11. The cooling system (1) for a motor vehicle (2) according to Numbered Paragraph 10, characterized in that there is a fourth switching valve (703) in a cab heating circuit return line (109), which is connected to the cab heating circuit (108) by the cab bypass valve (107), with which the cab heating circuit return line (109) can be connected to a condenser intake (506).
Numbered Paragraph 12. A motor vehicle (2) that has a cooling system (1) according to any of the preceding Numbered Paragraphs.

### LIST OF REFERENCE SYMBOLS

1 cooling system
2 motor vehicle
10 braking resistor
11 braking resistor coolant pump
12 braking resistor coolant circuit
100 driver's cab
101 cab heater
102 cab cooling element
103 first cab coolant pump
104 cab high-voltage heater
105 second cab coolant pump
106 cab heating circuit bypass
107 cab bypass valve
108 cab heating circuit
109 cab heating circuit return line
110 cab air heater
200 cooling module
20 first coolant cooler
202 second coolant cooler
203 fan
204 third coolant cooler
300 first thermal management module
301 first chiller
302 second chiller
303 first indirect condenser
304 first refrigerant circuit
400 electronics cooling circuit
401 electronic components
402 electronics circuit coolant pump
403 electronics circuit cooler bypass
404 electronics circuit bypass valve
405 first electronics circuit valve
406 second electronics circuit valve
407 heating circuit intake line
408 first coolant outlet
409 second coolant outlet
500 second thermal management module
501 third chiller
502 second indirect condenser
503 check valve
504 condenser coolant pump
505 second refrigerant circuit
506 condenser intake
507 fourth chiller
600 battery cooling circuit
601 battery
602 battery circuit coolant pump
603 battery circuit heater
700 first switching valve
701 second switching valve
702 third switching valve
703 fourth switching valve

1-12. (canceled)

13. A cooling system for a motor vehicle, comprising a first thermal management module and a second thermal management module, wherein the first thermal management module comprises a first refrigerant circuit and the second thermal management module comprises a second refrigerant circuit, wherein the first refrigerant circuit comprises a first indirect condenser, first chiller, and second chiller, which is parallel to the first chiller, wherein the second refrigerant circuit comprises a second indirect condenser and third chiller.

14. The cooling system for a motor vehicle according to claim 13, wherein the first chiller is connected to a cab cooling element in the driver's cab, wherein the second chiller and third chiller are connected to a battery cooling circuit, wherein the battery cooling circuit contains at least one battery.

15. The cooling system for a motor vehicle according to claim 13, wherein the second refrigerant circuit contains a fourth chiller in parallel to the third chiller.

16. The cooling system for a motor vehicle according to claim 14, further comprising a second switching valve that is upstream of the third chiller and a third switching valve that is downstream of the third chiller.

17. The cooling system for a motor vehicle of claim 13, further comprising a first coolant outlet on the first indirect condenser and a second coolant outlet on the second indirect condenser that is open into the same heating circuit intake line, further comprising a check valve between second coolant outlet and the heating circuit intake line.

18. The cooling system for a motor vehicle according to claim 17 wherein the cooling system comprises a first coolant cooler, a second coolant cooler, and a cab heating circuit, wherein the first coolant cooler and cab heater are each configured to be selectively connected to one another by a first switching valve.

19. The cooling system for a motor vehicle according to claim 18, wherein the cab heating circuit comprises a first coolant pump, and a high-voltage heater, and further comprising a cab bypass valve, with which a cab heating circuit bypass can be activated.

20. The cooling system for a motor vehicle according to claim 18, wherein the cooling system comprises an electronics cooling circuit, which is configured to be connected to the second coolant cooler by a first electronics circuit valve and second electronics circuit valve, further comprising an electronics circuit cooler bypass with an electronics circuit bypass valve that is upstream of the second coolant cooler, wherein the electronics cooling circuit comprises at least one electronic component that requires cooling.

21. The cooling system for a motor vehicle according to claim 20, wherein the cooling system comprises a braking resistor cooling circuit, which comprises a braking resistor and a coolant pump, wherein the braking resistor cooling circuit is connected to one of the second coolant cooler or a third coolant cooler.

22. The cooling system for a motor vehicle according to claim 21, wherein the second coolant cooler is configured to be connected to the first coolant cooler by the first electronics circuit valve and the second electronics circuit valve.

23. The cooling system for a motor vehicle according to claim 22, further comprising a fourth switching valve in a cab heating circuit return line, which is connected to the cab heating circuit by the cab bypass valve, with which the cab heating circuit return line can be connected to a condenser intake.

24. A motor vehicle that has a cooling system according to claim 13.
